(19) United States
(12) Patent Application Publication
(10) Pub. No.: US 2009/0317704 A1
(43) Pub. Date: Dec. 24, 2009

(54) PRISMATIC BATTERY WITH NOVEL INTER-CELL CONNECTION

(76) Inventors: Pui Tsang Peter Ling, Hong Kong (CN); Andrew Sung-On Ng, Hong Kong (CN)

Correspondence Address: BUCHANAN, INGERSOLL & ROONEY PC, POST OFFICE BOX 1404, ALEXANDRIA, VA, 22313-1404, US

(21) Appl. No.: 12/373,941

(22) PCT Filed: Jul. 13, 2007
(86) PCT No.: PCT/IB07/01981

§ 371 Date: Jan. 15, 2009

(30) Foreign Application Priority Data
Jul. 21, 2006 (CN) 06108188.9

(51) Int. Cl. H01M 2/24; H01M 6/42

(52) U.S. Cl. 429/159; 429/158; 29/623.1

(57) ABSTRACT

A battery includes a plurality of prismatic battery cells, wherein prismatic battery cells which are immediately adjacent to each other are connected by at least one inter-cell connector which extends across an inter-cell aperture. The adjacent prismatic battery cells are communicable through the inter-cell aperture, to provide continuity in conductivity and/or a continuity of conductance across the inter-cell aperture. The inter-cell connector forms a fluid sealing member and the part which extends trough the aperture may be tapered and threaded.

### FIELD OF THE INVENTION

This invention relates to prismatic batteries and, more particularly, to prismatic batteries comprising a plurality of prismatic battery cells. More specifically, although of course not solely limited thereto, this invention relates to rechargeable batteries with prismatic cells.

### BACKGROUND OF THE INVENTION

Batteries and battery cells with a prismatic shape are commonly known respectively as prismatic batteries and prismatic battery cells. Although most prismatic batteries and batteries cells have a rectangular or circular cross section, prismatic batteries can be of any appropriate prismatic shape without loss of generality.

A prismatic battery or battery module is typically constructed from a plurality of prismatic cells. Each cell is formed with an electrode plate group comprising a positive cell plate group and a negative cell plate group. Typically, each cell plate group comprises a plurality of electrode plates which are stacked in parallel. Electrode plates of a same polarity are electrically connected together along a lateral side to a current collector and electrode plates of opposite polarity are alternately stacked. A typical current collector comprises an elongate metal member, such as a metal bar extending along the full length of the electrode plates. This is distinguished from a cylindrical battery cell in which an electrode plate is helically wound or spirally coiled into an electrode plate group. Positive and negative electrode cell plate groups are connected respectively to the positive and negative current collectors.

In general, the term “prismatic battery cell” is understood by persons skilled in the art as a battery cell comprising a plurality of positive and negative electrode plates which are stacked in parallel with a separator intermediate an adjacent pair of positive and negative electrode plates. Each battery cell is then connected to an adjacent cell via a current collector as an interface. A cell sub-assembly comprising an electrode plate group and positive and negative current collectors is then sealed inside a prismatic housing to prevent leakage of electrolyte, and the packaged battery cell has an overall prismatic shape and hence the calling “prismatic battery cells”.

A prismatic battery typically comprises a plurality of prismatic battery cells connected or bundled together in parallel and/or in series. The plurality of prismatic cells is usually mounted in a moulded plastic housing comprising a plurality of cell compartments in which adjacent cell compartments are separated by a compartment wall. The battery has an overall prismatic shape and is therefore commonly referred to with the term “prismatic”.

In this specification, the term “prismatic battery cell” is used to describe generally a category of batteries and is not intended to restrict or limit to battery cells of an exact prismatic shape. More particularly, this term is used to describe a battery cell having positive and negative electrode plate groups in which each one of the electrode plate groups comprises a plurality of electrode plates which are stacked in parallel. In general, electrode plates of an electrode plate group of a polarity are electrically connected together along one lateral side and are electrically bound on the other, opposite side. The other side is typically kept in place due to sandwiching by electrode plates of the opposite plate group. Positive and negative electrode plates of an electrode plate group of a battery cell are alternately stacked with respect to each other so that, except for the outermost electrode plates, an electrode plate of one electrode plate group is sandwiched between a pair of electrode plates of the electrode plate group of the opposite polarity. Separators are disposed between an adjacent pair of positive and negative electrode plates in the manner commonly known by skilled persons or as appropriate. It will be appreciated that while it is common for prismatic battery cells to have rectangular electrode plates, it is neither essential nor strictly necessary that the electrode plates are rectangular.

Batteries with prismatic cells are used in many high current applications or in applications in which a high power density is required. For example, rechargeable prismatic batteries such as Nickel Metal Hydride (NiMH) batteries have been widely used as power sources for driving electrical vehicles (EV) or hybrid electrical vehicles (HEV) because of their superior energy density characteristics.

In general, electrical energy is produced by chemical reaction between the positive and negative electrode plate groups in the presence of a liquid or fluid electrolyte, for example, potassium hydroxide (KOH), in case of a NiMH battery. The electrical energy thus generated is delivered to a load first via the current collectors and then through the contact terminals. To meet power rating requirements, a plurality of battery cells are usually connected together to form a battery unit or a battery module. Battery cells are usually connected together by joining or welding the corresponding free upper and/or lower ends of the current collector of adjacent electrode plate groups. It is known that contact resistance between adjacent battery cells is an important source of internal resistance of a battery. A high internal resistance means high energy wastage as well as heat dissipation problems. Such energy wastage and heat generation are particularly undesirable for high current applications such as electrical vehicles or hybrid electrical vehicles since the battery efficiency will be adversely affected and internal heat thus generated needs to be dissipated to avoid premature failure, or battery damage due to over-heating.

In a conventional prismatic cell as shown in FIG. 1, inter-cell connections are typically made by resistance welding of a pair of counterpart connectors which are respectively disposed in their respective battery cells and which are respectively connected to the current collector of the respective electrode cell plate groups. A typical counterpart inter-cell connector comprises a rigid metal plate on which an indentation with dimensions comparable or smaller to that of the inter-cell aperture is formed, for example, by pressure stamping. The indentation on one side of the metal plate protrudes as a raised cap on the opposite side. The depth of the indentation or the height of the raised cap is such that when a pair of counterpart connectors are welded together, the counterpart connectors together with a pair of O-rings will provide inter-cell connection to a pair of adjacent cells and at the time sealing the inter-cell aperture. The formation of a skirt intermediate the raised cap and the base of the metal plate results in an area of increased resistance serially in the inter-cell connection path. In addition, welding between opposite surfaces of the two raised caps of the counterpart connectors is also known to introduce additional resistance and is difficult to ensure welding quality at the contact junction. Furthermore, high temperature weld of the raised caps may also damage or permanently deform the sealing rings. Moreover, it is also desirable that individual cell compartments are sealed since it is known that flow of electrolyte across cells will cause shortening of battery life.

Therefore, it is desirable if prismatic batteries with improved inter-cell connection can be provided to alleviate shortcomings of conventional prismatic batteries.

### SUMMARY OF THE INVENTION

According to the present invention, there is provided a battery comprising a plurality of interconnected prismatic battery cells wherein an adjacent pair of prismatic battery cells is connected by at least one inter-cell connector, each said inter-cell connector comprising an inter-cell conductor portion extending through an inter-cell aperture intermediate said adjacent pair of prismatic battery cells; characterised in that there is a continuity or a substantial continuity in physical properties of the inter-cell connector across said inter-cell aperture.

The physical properties may include, for example, conductivity, conductance, conductive area, conductive shape, resistance, resistivity, and/or metal grain properties of the conductor, and/or other physical characteristics in relation to inter-cell current conduction.

For example, the conductivity and/or conductance of said inter-cell connector across said inter-cell aperture may be constant or substantially constant.

For example, the conductivity or conductance of said inter-cell connector across said inter-cell aperture may be constant or substantially constant.

As a further example, the conductivity or resistivity of said inter-cell connector across said inter-cell aperture is uniform or substantially uniform.

An inter-cell conductor having a substantial continuity in physical properties across the inter-cell aperture would normally mean that there is no abrupt change of physical properties across the inter-cell aperture. Usually, this is criteria for minimum resistance or maximum conductance for optimal inter-cell connection.

In addition, the use of a conductor with substantial continuity in physical properties across the inter-cell aperture would also mean a substantial continuity in conductive area or conductive cross-section across the inter-cell aperture.

According to one aspect of the invention, there is provided a battery comprising a plurality of prismatic battery cells, wherein prismatic battery cells which are immediately adjacent to each other are connected by at least one inter-cell connector which extends across an inter-cell aperture, said adjacent prismatic battery cells being communicable through said inter-cell aperture; characterised in that there is a continuity in conductivity and/or a continuity of conductance across said inter-cell aperture.

As the resistance of an inter-cell connector is largely determined by the most resistive portion of the inter-cell connector in the inter-cell current path because of the series nature of an inter-cell connector, an inter-cell connector comprising an inter-cell conductor having a constant or substantially constant resistance and/or resistivity across the inter-cell aperture would mean that the conductivity of an inter-cell connector would not be determined by the resistance or resistivity of an abrupt junction such as a raised circumferential skirt or that of a welded junction between opposite raised caps of a conventional inter-cell connection.

In another aspect of this invention, there is provided a battery comprising a plurality of prismatic battery cells, wherein prismatic battery cells which are immediately adjacent each other are connected by at least one inter-cell connector which extends across an inter-cell aperture, said adjacent prismatic battery cells being communicable through said inter-cell aperture; characterised in that there is a continuity in conductive area of said inter-cell connector across said inter-cell aperture.

An inter-cell conductor with a constant or substantially constant conductance, and/or conductive area across said inter-cell aperture would mean that an adjacent pair of prismatic battery cells can be connected with an inter-cell connector of an optimal or maximally possible conductivity with regard to the dimension of an inter-cell aperture. Consequentially an inter-cell aperture of a battery with a relatively large current rating can be relatively small.

For example, the conductive area of said inter-cell connector may be constant or substantially constant across said inter-cell aperture.

In a typical example, said battery may comprise a housing having a plurality of cell compartments for accommodating said plurality of prismatic cells such that a said prismatic cell is accommodated in a said cell compartment, the prismatic cells which are immediately adjacent being connected by at least one said inter-cell connector which extends across a compartment wall separating the adjacent cell compartments through a said inter-cell aperture, the cell compartments containing said immediately adjacent prismatic cells being communicable through said inter-cell aperture.

At least the portion of said inter-cell connector which extends across said inter-cell aperture may be integrally formed or formed as a single piece.

When an integrally formed conductor is used as a bridging portion of an inter-cell connector there is no need to deform the current collectors, for example, by metal stamping, in order to form raised caps in the conventional manner preparation of the inter-cell welding. As deformation to the current collector would necessary result in changes to the physical properties of the current collector, for example, thinning of a current collector at the skirt regions and/or damaging of a protective layer (e.g., a nickel coating layer), the use of an un-deformed or integrally formed conductor for inter-cell connector would substantially mitigate shortcomings due to conventional ways of forming raised caps for making inter-cell connection.

The portion of said inter-cell connector which extends through said inter-cell aperture may form a fluid sealing member against leakage of electrolyte through said inter-cell aperture.

At least the portion of said inter-cell connector which extends through said inter-cell aperture is tapered, and said portion may also be configured as a fluid sealing member against leakage of electrolyte through said inter-cell aperture.

At least the portion of said inter-cell connector extending through said inter-cell aperture is tapered, and said inter-cell connector may be configured so that one longitudinal end of said inter-cell connector is insertable into said inter-cell aperture while the other longitudinal end has a transverse cross-section configured to seal said inter-cell aperture.

Each said prismatic cell may comprise an electrode plate group having a positive current collector and a negative current collector, corresponding current collectors of an adjacent pair of prismatic cells being connected by at least one said inter-cell connector.

Conductance of said inter-cell connector across said inter-cell aperture is at a maximum with regard to the dimension of said inter-cell aperture.

End flanges may be formed at respective longitudinal ends of said inter-cell connector to cap said inter-cell aperture.

Said inter-cell aperture may be formed on a compartment wall dividing two adjacent cell compartments, said flanges compressively engaging said compartment wall.

Said inter-cell conductor may comprise first and second ends which are located in different cell compartments, and immediately adjacent prismatic battery cells are joined at said first and second ends.

An adjacent pair of prismatic battery cells may be connected by at least one inter-cell connector by forming contacts outside said inter-cell aperture.

Each said contact may be formed by welding, soldering or by other fusion connection methods.

Electrical connection between an adjacent pair of prismatic cells and an inter-cell connector may be by making contacts at opposite ends of said inter-cell connector so that the portion of said inter-cell connector intermediate said contacts is unwelded.

Each said inter-cell connector may comprise fastening means for fastening and tightening said inter-cell connector onto a cell compartment wall.

A circumferential flange may be formed at a longitudinal end of said inter-cell connector, and the other longitudinal end of said inter-cell connector is threaded for receiving a threaded fastening means, said inter-cell connector being tightened onto a cell compartment wall by co-operation of said circumferential flange and said threaded fastening means.

Said threaded fastening means may comprise a threaded fastening nut.

Said inter-cell connector may be tapered towards a longitudinal end distal from said flange, and said inter-cell connector is dimensioned so that the distal end of said inter-cell connector is insertable into said inter-cell aperture, and wherein a cell partitioning wall is intermediate said distal end and flanged end of said inter-cell connector when said inter-cell connector is fastened and tightened onto said cell partitioning wall.

Current collectors of a said prismatic battery cell may have a C-cross-section, said inter-cell connector being joined to said current collector at middle of said C-cross section.

Said battery may be a Nickel metal hydride battery with potassium hydroxide electrolyte.

An adjacent pair of prismatic battery cells may be joined by a plurality of said inter-cell connectors on locations distributed along the length of a corresponding pair of current collectors.

According to the present invention, there is also described a method of forming an inter-cell connection between a pair of adjacent prismatic battery cells of a battery, the method comprising:
a. attaching and fastening an inter-cell connector to a cell partitioning wall, and
b. connecting said inter-cell connector to current collectors of an adjacent pair of prismatic battery cells.

Said method further may comprise a step of forming conductive junction contacts between said inter-cell connector and said current collectors of an adjacent pair of prismatic battery cells outside an inter-cell aperture.

In an application, the inter-cell connector may comprise an inter-connector with opposite ends, said method further comprising forming a pair of conductive junction contacts between an adjacent pair of prismatic battery cells at said opposite ends.

### BRIEF DESCRIPTION OF THE DRAWINGS

Preferred embodiments of the present invention will be explained in further detail below by way of examples and with reference to the accompanying drawings, in which:

FIG. 1 is a perspective view showing a particularly exploded and partly disassembled view of a prismatic battery with conventional inter-cell connections,

FIG. 1A is an enlarged cross-sectional view of an inter-cell connection of FIG. 1,

FIG. 2 shows an exploded view of a moulded battery housing illustrating disassembled inter-cell connectors of this invention,

FIG. 2A is an enlarged cross-sectional view of a partly formed inter-cell connection of FIG. 2,

FIG. 2B is an exploded view of an inter-cell connector,

FIG. 2C shows a cross-sectional view of an alternate preferred embodiment of an inter-cell connector.

FIG. 3 is shows an exploded view of a partly disassembled battery illustrating inter-cell connectors of this invention,

FIG. 3A is an enlarged cross-sectional view showing an inter-cell connection of FIG. 3, and

FIG. 3B is an enlarged perspective view showing an area on a current collector corresponding to the conductive contact junction.

### DETAILED DESCRIPTION OF THE PREFERRED EMBODIMENTS

In the specification below, although reference is made specifically to a Nickel-Metal-Hydride (NiMH) battery as a convenient illustration example, since Nickel-Metal-Hydride rechargeable batteries are widely used and are known to have a superior power density characteristic, reasonably priced and with a reasonable battery life, it would be appreciated by a skilled person that the principles and invention described in the present specification apply mutantis mutandis to other types of prismatic batteries, especially rechargeable prismatic batteries, comprising battery cells having electrode plates which are stacked in parallel, without loss of generality.

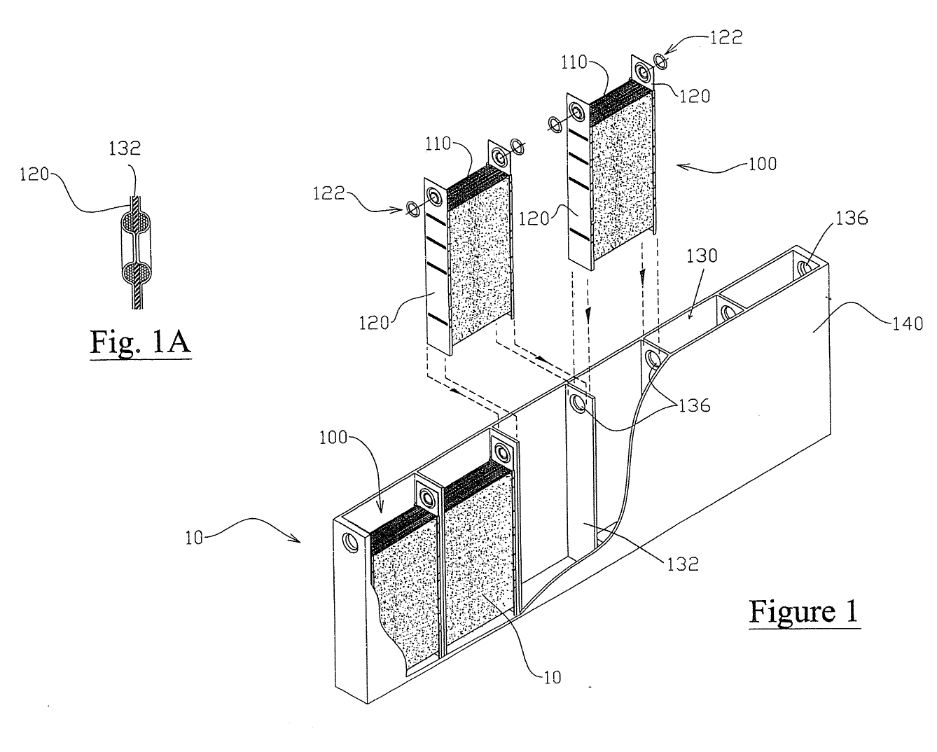

A typical prismatic battery or prismatic battery module 10 as shown in FIG. 1 comprises a plurality of prismatic battery cells 100 which are connected together, for example, to meet appropriate power rating requirements. Each battery cell 100 comprises an electrode plate group 110 which in turn comprises a positive electrode plate group and a negative electrode plate group. Each electrode plate group comprises a plurality of electrode plates and the positive and negative electrode plate groups together constitute the electrode plate group of a prismatic cell. Positive and negative electrode plates respectively from a positive electrode plate group and a negative electrode plate group are stacked alternately in parallel with separators interposed between an adjacent pair of electrode plates. Therefore, an electrode plate group of a prismatic battery cell comprises a positive electrode plate group and a negative electrode plate group 110 which are separated by separators (not shown). More particularly, the electrode plate groups are arranged so that positive electrode plates and negative electrode plates are interleaved with a separator interposed between each pair of positive and negative electrode plates. Corresponding longitudinal edges of the positive electrode plates on one side of a positive electrode plate group are connected along their length and are then connected to a positive current collector. Corresponding longitudinal edges of the negative electrode plates of a negative electrode plate group, which are on the opposite side of the connected longitudinal edges of the positive electrode plate group, are connected along their length and are then connected together to a negative current collector. Each of the electrode plates includes an active region and a lead region. The corresponding active regions of a pair of positive and negative plates are substantially overlapping and react in the presence of an electrolyte to convert chemical energy into electrical energy. The active regions of the electrode plates of a typical prismatic battery cell are substantially rectangular with one of the longer or longitudinal sides adjacent the lead portion. The lead portion is on one lateral side of an electrode plate, elongate, and is of substantially the same length as the longitudinal side of the active region. The rectangular active regions of the electrode plates are usually formed from the same base material. Both the active region and the lead portion have substantially the same length. Of course, the lead portion can be shorter or longer. Furthermore, it should be appreciated that while active regions are usually rectangular, it is not strictly necessary so and active regions of other shapes can be used without loss of generality.

In a typical conventional Nickel-Metal-Hydride rechargeable battery, the active regions of the positive electrode plates are made of a nickel-foamed metal coated with nickel hydroxide. The active regions of the negative electrode plates are made of a nickel punched metal sheet coated with negative electrode constituting materials such as a hydrogen-absorbing alloy. The electrode plates are typically very thin to reduce material costs and weight since the electricity generating reaction is surface in nature. Current collectors 120 are usually nickel-plated copper or steel for good thermal and electrical conductivity. For prismatic battery cells in which the electrode plates are connected to the current collectors by electronic beam welding, resistance welding or carbon dioxide laser welding, the current collectors are typically thin nickel-plated metallic plates since the actual welding junction is behind the approaching surface of the welding source.

In forming the electrode plate groups 110, corresponding lead portions of the electrode plates are first bundled together. Bundling in the present context including but not limited to the pressing, packing, gathering, welding or fastening together of the respective lead portions of the electrode plate groups. The bundled lead portions may then be maintained in form by soldering, welding or mechanical fastening means such as riveting. Furthermore, before the lead portions are bundled together, the electrode groups are usually already in an interleaving configuration with adjacent electrode plates of an opposite polarity in a closely packed relationship.

After the electrode plates have been bundled together, they are sub-assembled with the current collectors. The sub-assembly will then be inserted into a prismatic battery housing 140 and adjacent battery cells 110 are connected together by inter-cell connections to form a battery or a battery module when filled with an electrolyte.

To form an inter-cell electrical connection, a current collector is processed so that a toroidal indentation with an elevated cap is formed in the middle. The elevated caps of the corresponding pair of adjacent current collectors are welded together to form an inter-cell electrical connection while the toroidal portions are fitted with O-rings 122 for inter-cell sealing. The elevated caps are shaped and dimensioned to be received within an inter-cell aperture 136 and with a welded junction formed within the inter-cell aperture 136.

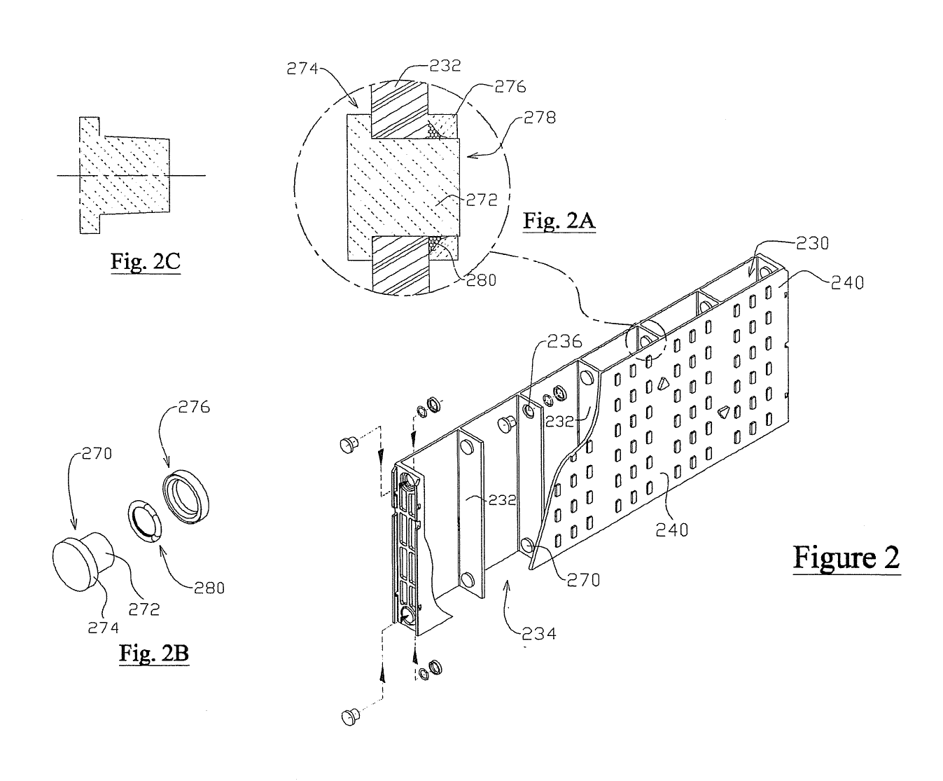

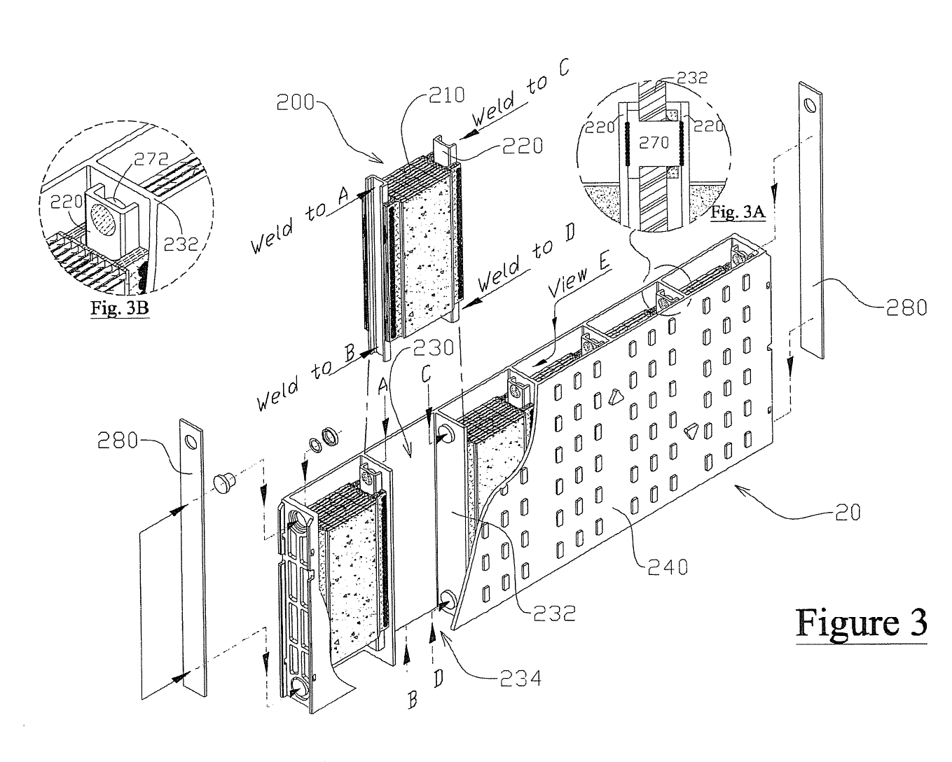

Referring to FIGS. 2, 2A, 3 and 3A, an exemplary prismatic battery 20 of this invention comprises a plurality of battery cells 200 which are connected together. Each battery cell comprises an electrode plate group 210 with positive and negative current collectors 220 on opposite sides. The electrode plate groups 210 are identical to that of a conventional electrode plate group 110 described above. Each electrode plate group 210 is inserted into a cell compartment 230 of the battery housing 240 so that individual cell plate groups are separated from each other while adjacent cell plate groups are electrically connected via their respective current collectors 220 by means of an inter-cell connector 250.

The battery housing 240 is moulded, for example, from hard plastics or resins and is preformed into a plurality of cell compartments 230 with a plurality of partitioning walls 232 separating adjacent cell compartments. As is more particularly shown in FIG. 2, each cell compartment 230 is substantially rectangular with substantially rectangular partitioning walls 232 defining the lateral limits of each cell compartment. In other words, the housing 240 is substantially rectangular and comprising a plurality of rectangular cell compartments with parallel partitioning walls 232. The bottom end of each cell compartment is opened or partially opened with an aperture 234 formed adjacent to each partitioning wall to facilitate welding or soldering between an inter-cell connector and a current collector to be explained below. The upper end of the cell compartments is fully opened and will be covered by a top cover when the assembly has been completed. Inter-cell apertures 236 are formed near the upper and lower ends of the partitioning walls 232 to provide guided paths for inter-cell connections between an adjacent pair of prismatic battery cells to be explained below.

Referring to FIGS. 2 and 2A, inter-cell connectors for forming inter-cell connections between an adjacent pair of prismatic battery cells are shown in more detail. The inter-cell connector 270 comprises a first portion and a second portion which together form a conductive fastening means for making inter-cell electrical connections. The first portion of the inter-cell connector comprises a headed inter-cell conductor with a solid conductive portion 272 protruding from a flange end 274 with its free end most distal from the flange end. The solid conductive portion is substantially a conductive shaft with a cross-section comparable or slightly larger than that of an inter-cell aperture 236 so that the inter-cell aperture would be filled or substantially filled by the solid conductive portion when an inter-cell connection has been made. For example, the solid conductive portion can have a circular cross-section for a circular inter-cell aperture. For an inter-cell aperture with a cylindrical cross-section, the first portion of the inter-cell connection has a T-shaped longitudinal cross-section as shown in FIG. 2A. The second portion of the inter-cell connector comprises a lock nut 276 which is used to fasten the first portion of the inter-cell connector onto a partitioning wall 232. The free end 278 of the first portion of the inter-cell connector is threaded (for example, by external threads), for coupling to couple with the internal thread on the locking nut for forming a complete conductive fastening means across the partitioning wall 232. To enhance inter-cell sealing, a sealing means such as an O-ring 280 is inserted between the lock nut 276, the partitioning wall 232 and portion of the conductive shaft of the first portion immediately protruding from the partitioning wall so that a liquid seal is formed around the inter-cell aperture 236 at the junction at which the solid conductive shaft of the first portion protrudes from the partitioning wall 232. The first portion can be a single piece of metal made, for example, of copper, copper alloy, nickel plated copper, nickel plated steel, or other conductive materials. The lock nut can be made of similar conductive substances or non-conductive substances, since its main task is for fastening the first portion tightly onto the partitioning wall 232. The sealing ring can be a rubber, silicone or other polymeric sealing rings.

Initially, an inter-cell connector 270 is inserted onto the inter-cell aperture 270 and tightened onto the partitioning wall 232 by a lock nut 276 to form a conductive inter-cell conductive path between an adjacent pair of cell compartments. After an inter-cell conduction path has been made, electrode plate groups 210 are inserted into the cell compartments 230.

As shown in FIGS. 3, 3A and 3B, each electrode plate group 210 comprises a pair of current collectors 220 disposed on opposite lateral sides with free ends protruding above the longitudinal ends of the electrode plate groups. In this specific example, each of the current collectors protrudes beyond the longitudinal ends of the electrode plate groups so that inter-cell connections could be made at both the upper and lower ends of the current collectors. If only a single inter-cell connection is required between an adjacent pair of battery cells, the current collector may only protrude beyond one longitudinal end, for example, either the upper end or the lower end.

In a preferred embodiment as shown in FIG. 2B, the solid conductive shaft 272 of the first portion is tapered towards its free end 278 so that the solid conductive shaft can operate additionally as an inter-cell plug to block an inter-cell aperture with increasing tightness when the inter-cell connector is tightened across a partitioning wall.

After the inter-cell connectors 270 have been assembled onto the battery housing by fastening to the inter-cell partitioning walls, the electrode plate groups 210 are placed into the cell compartments. The electrode plate groups 210 are arranged and configured so that when an electrode plate group is in position within a cell compartment, the pair of current collectors on both lateral sides of the electrode plate groups will be in close proximity or in actual frictional contact with the corresponding inter-cell connectors of adjacent battery cells or a terminal connector if the electrode plate group is in the first or the last cell compartment. In other words, the separation between the free outer surfaces of a pair of current collectors 220 on the lateral sides of an electrode plate group would be substantially identical to the separation between the free ends of a pair of opposite inter-cell connectors on the opposite partitioning walls of an intermediate cell.

In this preferred embodiment, a current collector has a C-shaped cross-section with a longitudinal channel end formed along its length. The longitudinal channel is configured so that when an electrode plate group is inserted into a cell compartment with the channel openings aligned to the flange heads of an opposing pair of inter-cell connectors on the partitioning walls, the electrode plate group will be guided into position with the flange ends aligned with the protruding ends of the current collectors. Similar to conventional current collectors, the current collector can be made, for example, of copper, copper alloy, nickel plated copper, nickel plated steel or other conductive materials such as alloys. An additional advantage of using a current collector with a C-shaped cross-section is that lead portions of an electrode plate group can be attached to the two sides of the current collector as shown in FIG. 3.

After the electrode plate groups have been inserted into the cell compartments as shown in FIG. 3, inter-cell connections will be made. The inter-cell connections are made by joining an inter-cell connector to the current collectors of an adjacent pair of prismatic battery cells, for example, by fusion connection methods such as soldering or welding such as resistance welding, spot welding, laser welding or like methods. As more particularly shown in FIGS. 2A and 2B, an inter-cell connector comprises a solid conductive portion in the form of a solid conductive shaft extending transversely across adjacent cell compartment, the longitudinal free ends of the solid conductive portions protrude beyond the edges of a partitioning wall and are in contact with corresponding current collectors. Inter-cell electrical connections are established when both ends of the solid conductive portions of an inter-cell connector are electrically attached to the corresponding current collectors as more particularly shown in FIG. 3A. With the application of an inter-cell connector of this invention, a solid conductor extends fully between a pair of current collectors of adjacent prismatic battery cells. The term “solid” when used in this specification means substantially solid. A “solid conductor” in this specification includes a solid conductor with an axial bore, especially when the cross-sectional area of the bore is smaller than the cross-sectional area of the conductive portion.

Because contact junctions are made at the free ends of the solid conductive portion, the effective cross-sectional area for inter-cell current conduction using an inter-cell connector of this invention is substantially more than that of an inter-cell connection made according to conventional methods. In addition, a solid conductor with a cross-sectional dimensions comparable to that of an inter-cell aperture means a more significant heat mass such so that the temperature increase in the proximity of the contact junction would be lower compared to formation of contact junctions according to conventional methods. As it is well known that high temperature fusion connection will cause change of metallic properties proximal the contact junctions, such an inter-cell connection method provides further advantages.

After the inter-cell connectors have been joined to the current collectors, the bottom part of the pre-housing will be sealed and the battery housing will be filled with an electrolyte and then the top of the battery housing is sealed to form a complete sealed battery.

Although an inter-cell conductor with a solid inter-cell conductor has been illustrated, it will be appreciated that the inter-cell conductor may not be solid, it can be an integral piece with a bore or can be an ensemble of conductors. Preferably, the area of the conductive portion of an inter-cell connector in an inter-cell aperture exceeds 50% that of the area of the aperture.

For electrode plate groups at the ends of a battery, one of the current collectors will be connected to an end terminal through a terminal connectors 280 for making external electrical connections. As more particularly shown in FIG. 3B, the hatched portion indicates the approximate area of a junction contact between a free end and an inter-cell connector and a current collector.

While the present invention has been explained by reference to the preferred embodiments described above, it will be appreciated that the embodiments are illustrated as examples to assist understanding of the present invention and are not meant to be restrictive on the scope and spirit of the present invention. Variations or modifications which are obvious or trivial to persons skilled in the art, as well as improvements made on the basis of the present invention, should be considered equivalents of the present invention.

Furthermore, while the present invention has been explained by reference to a rectangular NiMH prismatic battery, it should be appreciated that the invention can apply, whether with or without modification, to other prismatic batteries without loss of generality.

1. A battery comprising a plurality of prismatic battery cells, wherein prismatic battery cells which are immediately adjacent to each other are connected by at least one inter-cell connector which extends across an inter-cell aperture, said adjacent prismatic battery cells being communicable through said inter-cell aperture; wherein there is a continuity in conductivity and/or a continuity of conductance across said inter-cell aperture.

2. A battery according to claim 1, wherein the conductivity and/or conductance of said inter-cell connector across said inter-cell aperture is constant or substantially constant.

3. A battery according to claim 1, wherein the conductivity or conductance of said inter-cell connector across said inter-cell aperture is constant or substantially constant.

4. A battery according to claim 1, wherein the conductivity or resistivity of said inter-cell connector across said inter-cell aperture is uniform or substantially uniform.

5. A battery comprising a plurality of prismatic battery cells, wherein prismatic battery cells which are immediately adjacent each other are connected by at least one inter-cell connector which extends across an inter-cell aperture, said adjacent prismatic battery cells being communicable through said inter-cell aperture; wherein there is a continuity in conductive area of said inter-cell connector across said inter-cell aperture.

6. A battery according to claim 5, wherein the conductive area of said inter-cell connector is constant or substantially constant across said inter-cell aperture.

7. A battery according to claim 1, wherein said battery comprises a housing having a plurality of cell compartments for accommodating said plurality of prismatic cells such that a said prismatic cell is accommodated in a said cell compartment, the prismatic cells which are immediately adjacent being connected by at least one said inter-cell connector which extends across a compartment wall separating the adjacent cell compartments through a said inter-cell aperture, the cell compartments containing said immediately adjacent prismatic cells being communicable through said inter-cell aperture.

8. A battery according to claim 1, wherein at least the portion of said inter-cell connector which extends across said inter-cell aperture is integrally formed or formed as a single piece.

9. A battery according to claim 1, wherein the portion of said inter-cell connector which extends through said inter-cell aperture forms a fluid sealing member against leakage of electrolyte through said inter-cell aperture.

10. A battery according to claim 1, wherein at least the portion of said inter-cell connector which extends through said inter-cell aperture is tapered, and said portion is also configured as a fluid sealing member against leakage of electrolyte through said inter-cell aperture.

11. A battery according to claim 1, wherein at least the portion of said inter-cell connector extending through said inter-cell aperture is tapered, and said inter-cell connector is configured so that one longitudinal end of said inter-cell connector is insertable into said inter-cell aperture while the other longitudinal end has a transverse cross-section configured to seal said inter-cell aperture.

12. A battery according to claim 1, wherein each said prismatic cell comprises an electrode plate group having a positive current collector and a negative current collector, corresponding current collectors of an adjacent pair of prismatic cells being connected by at least one said inter-cell connector.

13. A battery according to claim 1, wherein conductance of said inter-cell connector across said inter-cell aperture is at a maximum with regard to the dimension of said inter-cell aperture.

14. A battery according to claim 1, wherein end flanges are formed at respective longitudinal ends of said inter-cell connector to cap said inter-cell aperture.

15. A battery according to claim 14, wherein said inter-cell aperture is formed on a compartment wall dividing two adjacent cell compartments, said flanges compressively engaging said compartment wall.

16. A battery according to claim 1, wherein said inter-cell conductor comprises first and second ends which are located in different cell compartments, and immediately adjacent prismatic battery cells are joined at said first and second ends.

17. A battery according to claim 1, wherein an adjacent pair of prismatic battery cells is connected by at least one inter-cell connector by forming contacts outside said inter-cell aperture.

18. A battery according to claim 17, wherein each said contact is formed by welding, soldering or by other fusion connection methods.

19. A battery according to claim 1, wherein electrical connection between an adjacent pair of prismatic cells and an inter-cell connector is by making contacts at opposite ends of said inter-cell connector so that the portion of said inter-cell connector intermediate said contacts is unwelded.

20. A battery according to claim 1, wherein each said inter-cell connector comprises fastening means for fastening and tightening said inter-cell connector onto a cell compartment wall.

21. A battery according to claim 1, wherein a circumferential flange is formed at a longitudinal end of said inter-cell connector, and the other longitudinal end of said inter-cell connector is threaded for receiving a threaded fastening means, said inter-cell connector being tightened onto a cell compartment wall by co-operation of said circumferential flange and said threaded fastening means.

22. A battery according to claim 21, wherein said threaded fastening means comprises a threaded fastening nut.

23. A battery according to claim 21, wherein said inter-cell connector is tapered towards a longitudinal end distal from said flange, and said inter-cell connector is dimensioned so that the distal end of said inter-cell connector is insertable into said inter-cell aperture, and wherein a cell partitioning wall is intermediate said distal end and flanged end of said inter-cell connector when said inter-cell connector is fastened and tightened onto said cell partitioning wall.

24. A battery according to claim 1, wherein current collectors of a prismatic battery cell have a C-shaped cross-section, said inter-cell connector being joined to a current collector at the middle of said C-shaped cross section.

25. A battery according to claim 1, wherein said battery is a Nickel metal hydride battery with potassium hydroxide electrolyte.

26. A battery according to claim 1, wherein an adjacent pair of prismatic battery cells are joined by a plurality of said inter-cell connectors on locations distributed along the length of a corresponding pair of current collectors.

27. A method of forming an inter-cell connection between a pair of adjacent prismatic battery cells of a battery, the method comprising:
i. attaching and fastening an inter-cell connector to a cell partitioning wall, and
ii. connecting said inter-cell connector to current collectors of an adjacent pair of prismatic battery cells.

29. A method according to claim 27, wherein inter-cell connector comprises an inter-connector with opposite ends, said method further comprising forming a pair of conductive junction contacts between an adjacent pair of prismatic battery cells at said opposite ends.
